(19) United States
(12) Patent Application Publication
(10) Pub. No.: US 2004/0138361 A1
(43) Pub. Date: Jul. 15, 2004

(54) High density composition of matter, articles made therefrom, and processes for the preparation thereof

(76) Inventor: Paul P. Cheng, Washington, WV (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/636,856

(22) Filed: Aug. 7, 2003

Related U.S. Application Data
(60) Provisional application No. 60/401,543, filed on Aug. 7, 2002.

(51) Int. Cl. C08L 77/00

(52) U.S. Cl. 524/401; 524/406

(57) ABSTRACT

A high density polymer composition made from compositions comprising (a) polymeric binder comprising polyamide compositions and blends and based on monomers comprising hexamethylenediamine and/or caprolactam, and phenolic novolac resin, and (b) metal or metal alloy powder is disclosed. Articles made from the composition are disclosed. Bullets and other forms of ammunition are preferred articles. Processes for their preparation are also disclosed.

### CROSS REFERENCE TO RELATED APPLICATIONS

This application claims the benefit of U.S. Provisional Application No. 60/401,543, filed Aug. 7, 2002.

### FIELD OF THE INVENTION

This invention relates to a high-density polymeric composition comprising polymeric binder and metal powder filler. This invention also relates to bullets, other projectiles, and other molded articles requiring a high density that are made from these compositions and processes for their manufacture.

### BACKGROUND OF THE INVENTION

There is a growing trend in manufacturing to replace metal parts and components with those made from plastic. Plastics have the advantage of often being more inexpensive than metals and allow for greater design flexibility, as they can be molded into a wide variety of complex forms that would be difficult or costly to make from metals. Although plastics are also often used to replace metals in applications where lighter-weight materials would be at an advantage, it is also frequently desirable to use plastics in applications where the high density of a metal is required.

An example of such an application is in ammunition. Traditionally, ammunition has been manufactured by encapsulating a core of inexpensive heavy metal (such as lead) in an outer coating of another metal (such as copper) and then loading it into a shell casing with gunpowder and a primer. Alternatives to the use of lead are of widespread interest in this field.

A replacement for lead in the manufacture of bullets would clearly be desirable if it possessed the advantages of lead, viz., a low cost, and a relatively high density. The latter is important because the mechanisms of modern firearms require bullets of a certain mass in order to function properly. Moreover, it is necessary to closely approximate the density of traditional lead bullets in order to ensure consistent behavior in the case of practice ammunition for law enforcement or military applications where a lead-free bullet would be used for training purposes only.

European Patent No. 0 096 617 B1 describes a practice bullet made from a plastic loaded with metal or alloy particles, preferably bronze, copper, or lead, containing also a solid lubricant, and possessing of a specific gravity of 3-5. Many traditional lead bullets have significantly greater specific gravities, however.

PCT Patent Application No. 88/09476 describes a bullet possessing a specific gravity of from 3 to 7 comprising a plastic material that absorbs at least as much moisture as nylon 66, and a metal filler material. Again, many traditional bullets have greater specific gravities. In addition, because of the close tolerances involved in the action of a firearm, it is desirable that bullets possess significant dimensional stability when exposed to moisture. Nylon 66 absorbs significant amounts of moisture in humid environments, and hence when used alone will be a sub-optimal material for this application.

European Patent No. 0 625 258 B1 describes a bullet consisting essentially of fine copper powder and nylon 11 or nylon 12 with a specific gravity of between about 5.7 and 6.6. Again, it would be desirable to make a lead free bullet with a greater specific gravity. Additionally, nylons 11 and 12 are rather expensive materials.

U.S. Pat. No.6,048,379 describes a composition of matter suitable for making bullets comprising tungsten powder, a binder, and, optionally, stainless steel fibers. The binder is preferably nylon 12. Again, this requires the use of expensive materials.

U.S. Pat. No. 6,257,149 describes a bullet comprising a core of lead-free filler and a polymer and an outer jacket of either a polymer or copper. This requires a more complicated process to produce than bullets made of a single material.

There is still a need for a high density polymer composition that has a sufficiently high density to serve as an adequate replacement for lead and other metals, has good dimensional stability in the presence of moisture, and is made from inexpensive materials. It is therefore an object of the present invention to provide a composition suitable for the manufacture of molded articles, including bullets and other ammunition, that exhibits these qualities. It is a further object of the present invention to provide bullets that meet or exceed stringent tolerances and specifications, so that upon discharge their trajectory is both predictable and reproducible. A feature of the instant invention is that compositions disclosed herein are readily moldable to suit any of a variety of shapes and configurations of ammunition and other molded articles of interest. An advantage of the instant invention is the ease of manufacture of molded articles, including bullets of these compositions, and conventional molding techniques are readily adaptable for this purpose. These and other objects, features and advantages of the invention will become better understood upon having reference to the description of the invention herein.

### SUMMARY OF THE INVENTION

There is disclosed and claimed herein a high density polymer composition comprising (a) polymeric binder comprising polyamide, and phenolic novolac resin, and (b) metal or metal alloy powder. Preferably the metal selected is tungsten. Preferably the polyamide is one more polyamides based on monomers comprising hexamethylenediamine and/or caprolactam. Optionally, the composition may contain inorganic fibrous filler such as glass, and other additives including antioxidants, stabilizers, lubricants, and processing aids. Moreover, processes for the preparation of ammunition made from the above compositions are also disclosed and claimed herein. Bullets made from these compositions are of particular interest.

### DETAILED DESCRIPTION OF THE INVENTION

### General Description

There are a variety of metals and alloys available that are, when combined with the polymer binder of the present invention, sufficiently dense and environmentally attractive to adequately replace metals in many applications. In particular, they are adequate to replace lead in ammunition applications. A preferred choice is tungsten, which is a relatively environmentally attractive, readily-available metal with a density of 19.3 g/mL, making it ideally suited for a bullet application. In the present invention, metal or alloy powder is combined with a polymer binder, and, optionally, inorganic fibers, and/or additives to make a high-density plastic-based material that is suitable for use in such applications.

As used herein, “ammunition” refers to any of a variety of commonly understood articles capable of being fired or discharged from a firearm or other device. Further, “bullets” refers to any of a variety of commonly understood articles that are generally cylindrical in shape and with a conical contour towards the leading edge. They may be pointed or rounded at the leading edge, for example. Moreover, they may also be jacketed or otherwise include casings as will be appreciated to those of skill in this field.

For many applications that require the replacement of metal parts with plastic parts, it is desired that the polymer compositions used have good dimensional stability when exposed to moisture. For example, because of the high tolerances involved in the operation of firearms and the varied conditions under which they are used, it is important that the polymer binder used be dimensionally stable upon exposure to moisture. It is also important that the polymer binder that is used in a bullet be sufficiently strong and adhere sufficiently well to the metal or alloy powder that the bullet has sufficient mechanical integrity to survive the firing process and reach its target intact.

In many senses, polyamides are an ideal choice for these applications: they are easily molded, have good physical properties, and can take the high loadings of metal or alloy powder that are necessary to achieve the high densities desired. However these materials have been consistently rejected as not suitable for these applications, due to their propensity to absorb moisture. This in turn can lead to warpage and other dimensional changes in polyamide parts. Nylon 11 and nylon 12 have significantly lower equilibrium moisture contents than more common polyamides such as nylon 66 or nylon 6, but are also significantly more expensive, in large part due to the cost of their corresponding monomers.

It has been unexpectedly discovered that polyamides, preferably those based on low-cost monomers such as hexamethylenediamine or caprolactam, or blends thereof in combination with a novolac phenolic resin and, optionally, glass fibers will, when combined with a high-density metal or alloy powder, provide a high-density material that has good dimensional stability in the presence of moisture and low melt viscosity. This material is sufficiently dimensionally stable in the presence of moisture to produce high-quality bullets and other molded articles.

In order to fire properly and have consistent trajectory behavior, it is important that bullets be of a fairly uniform density throughout. It has been found that the combination of a polyamide or polyamide blend with novolac phenolic resin and glass fibers used as a binder for a high-density metal or alloy powder of the present invention can be easily injection-molded into bullets that have a sufficient density and uniformity to consistently fire properly. During injection molding, voids often form in molded parts. The formation of voids is difficult to control and is often a function of the temperature difference between the molten resin and the molding tool and heat transfer in the molten resin. The presence of voids in bullets will affect their firing ability and accuracy, particularly when the voids are large or not uniformly distributed. The compositions of the present invention have low melt viscosities, which allows for lower melt temperatures to be used during molding. Additionally, the use of the phenolic novolac resin lowers the freezing point of the compositions relative to compositions containing polyamides along. These two factors mean that minimal voids are generated when the compositions of the present invention are molded.

Minimal voids are also desirable for other articles made from the compositions of the present invention. Since the presence of voids will lower the density of a molded article, it is advantageous for a high density composition to be molded in a fashion that minimizes the formation of voids. Voids inside molded articles can act as stress risers that can lead to breakage and failure of the articles. Additionally, a low melt viscosity permits complicated molds to be filled quickly and can produce molded articles with smoother surfaces, when desired.

The ingredients are combined, using any reasonable melt-processing method, such as extrusion, and the resulting high-density material is formed into articles, using a method such as injection molding. It will be readily appreciated that the melt processing and molding techniques useful herein may be selected from any of a variety of well-known and conventional sources.

Metal or Alloy Powder

The metal or alloy powder used in this invention is preferably copper, iron, or tungsten powder and is present in from about 50 to about 96 weight percent, or preferably, in from about 60 to about 92 weight percent, or more preferably, in from about 70 to about 91 weight percent of the composition. Tungsten powder is more preferred. The metal or alloy powder used in this invention can have a wide range of particle size distributions. It will preferably have particles with sizes that fall within the range of about 1 to about 100 microns. The particle size distribution will preferably be unimodal.

Polymer Binder

The polymer binder of this invention comprises a polyamide component and a thermoplastic novolac phenolic resin component that is miscible with the polyamide component. The polyamide component preferably comprises low-cost polyamides based on (meaning derived from or synthesized or prepared from) inexpensive monomers such as hexamethylenediamine and caprolactam. Suitable polyamides include nylon 66; nylon 6; nylon 612; the terpolymer obtained by polymerizing hexamethylenediamine, adipic acid, and terephthalic acid (nylon 6T/66); the terpolymer obtained by polymerizing hexamethylenediamine, 2-methyl-1,5-pentanediamine, and terephthalic acid (6T/DT); as well as other examples that will be obvious to those skilled in the art. The polyamide component can consist of blends of any suitable polyamides. In a preferred embodiment of this invention, the polyamide component will consist of a blend of nylon 66 and nylon 6.

Novolac phenolic resins are thermoplastic phenol-formaldehyde resins that are preferably prepared by reacting at least one aldehyde with at least one phenol or substituted phenol in the presence of an acid or other catalyst such that there is a molar excess of the phenol or substituted phenol. Suitable phenols and substituted phenols include phenol, o-cresol, m-cresol, p-cresol, thymol, p-butyl phenol, tert-butyl catechol, resorcinol, bisphenol A, isoeugenol, o-methoxy phenol, 4,4′-dihydroxyphenyl-2,2-propane, isoamyl salicylate, benzyl salicylate, methyl salicylate, 2,6-di-tert-butyl-p-cresol, and the like. Suitable aldehydes and aldehyde precusors include formaldehyde, paraformaldehyde, polyoxymethylene, trioxane, and the like. More than one aldehyde and/or phenol may be used in the preparation of the novolac. A blend of two more different novolacs may also be used.

The polyamide used in the present invention will preferably comprise about 20 to about 98 weight percent, or more preferably about 40 to about90 weight percent, or even more preferably, about 50 to about90 weight percent of the polymer binder. The novolac phenolic resin will preferably be present in about 2 to about 80 weight percent, or more preferably about 10 to about 60 weight percent, or even more preferably in about 10 to about 50 weight percent of the polymer binder. The polymer binder will be present in about 4 to about 50 weight percent of the total composition, or preferably, in from about 8 to about 60 weight percent, or more preferably, in from about 9 to about 30 weight percent of the composition.

Glass Fibers and Other Additives

The composition of the present invention can optionally include up to about 10 weight percent of inorganic fibers (for example, glass fibers). In a preferred embodiment, it will include about 0.1 to about 10 weight percent, more preferably, about 0.1 to about 8 weight percent, and even more preferably about 0.1 to about 6 weight percent of inorganic fibers,. Other additives, such as processing aids, antioxidants, stabilizers, and lubricants, as will be understood by those skilled in the art can be present in up to about 2 weight percent of the total composition, and will preferably be present in about 0.1 to about 2 weight percent of the total composition.

The compositions of the present invention may be formed into a wide variety of articles using thermoplastic processing methods known to those skilled in the art, such as injection molding. Example of articles include bullets, shot, and other ammunition; styluses and pointers for personal digital assistants and other electronic devices; housings for electronic devices such as portable consumer electronics; balance weights; radiation-shielding parts; dampers for steering wheels; and decorative articles and packaging. The compositions of the present invention are particularly suitable for use in applications that require both a high density composition of matter and significant design flexibility or for applications with awkward shapes that would be difficult or costly to make from metals.

It is to be readily appreciated that a large number of variations and modifications of the technology disclosed herein can be made that are consistent with the spirit and scope of the invention claimed herein. Any such changes are contemplated as being within the purview of the subject invention.

### EXAMPLES

The ingredients used in Examples 1-5 and Comparative Examples 1 and 2 and shown in Tables 1 and 2 were combined in a 40 mm Werner & Pfleiderer twin-screw extruder operating at 300-400 pounds per hour and 200-300 RPM. The barrels of the extruder were set at about 280° C. and a vacuum port was used. Glass fibers were side-fed and the other ingredients were rear-fed. Upon exiting the extruder, the polymer was passed through two- or three-hole dies to make strands that were frozen in a quench tank and subsequently chopped to make pellets. The pellets were molded into ISO flexural bars.

The 0.25 inch thick, 0.5 inch wide flexural bars were cut into pieces 1.5-2 inches long. The specific gravities of the resulting pieces were measured by weighing each piece dry and then re-weighing the same piece immersed in a tared beaker of water. The specific gravity was the dry weight divided by the difference between the dry and immersed weights. The measurement was performed on pieces dry as molded and after the same pieces had been conditioned by being submerged in water for 24 hours. The former measurement is given in Tables 1 and 2 as “initial specific gravity” and the latter as “specific gravity after conditioning.” The percentage changes in specific gravity, volume, and weight for the sample after conditioning as compared to that before conditioning are given in Tables 1 and 2 for each of the samples. The more water that is absorbed by the compositions in the examples, the more negative is the percentage change in specific gravity that is observed and the greater is the change in volume and weight that is observed. The width of the pieces was also measured at the same point before and after conditioning and the increase in width resulting from the conditioning is given in Tables 1 and 2 as “change in width.” A greater increase in width signifies a lower degree of dimensional stability of the part in the presence of moisture.

Flexural modulus was measured using ASTM D790-58T on samples of Examples 1-5 and Comparative Examples 1 and 2. The sample bars were tested both dry as molded and after they had been conditioned by immersion in water at room temperature for 48 hours. The retention in flexural modulus was determined by dividing the flexural modulus after conditioning by that before conditioning and the results are given in Tables and 1 and 2 as “percentage retention of flexural modulus.”

The melt viscosity of Examples 4 and 5 and Comparative Example 2 were measured at five shear rates at 280° C. The results are given in Table 3. Freezing points were measured by DSC. Samples were heated at 10°C./minute to 300° C. and then allowed to cool at 10° C./minute. The peak of the first freezing peak observed is reported in Table 2 as “freezing point.”

TABLE 1

| | | | | Comparative |
|---|---|---|---|---|
| | Example 1 | Example 2 | Example 3 | Example 1 |
| Polyamide 66 | 6 | 5.4 | 4.8 | 6.6 |
| Polyamide 6 | 4 | 3.6 | 3.2 | 4.4 |
| Novolac | 1 | 2 | 3 | — |
| Tungsten powder | 85 | 85 | 85 | 85 |
| Glass fibers | 4 | 4 | 4 | 4 |
| Initial specific | 6.20 | 6.22 | 6.29 | 6.20 |
| gravity | | | | |
| Specific gravity | 6.13 | 6.18 | 6.26 | 6.11 |
| after conditioning | | | | |
| % Change in | −1.0 | −0.7 | −0.5 | −1.4 |
| specific gravity | | | | |
| % Change in | 1.37 | 0.88 | 0.65 | 1.82 |
| volume | | | | |
| % Change in | 0.31 | 0.21 | 0.18 | 0.38 |
| weight | | | | |
| % Change in width | 1.21 | 0.86 | 0.40 | 1.71 |
| Flexural Modulus | 10983 | 11956 | 11638 | 9666 |
| (DAM) (MPa) | | | | |
| Flexural Modulus | 3640 | 5061 | 7543 | 3558 |
| (after conditioning) | | | | |
| (MPa) | | | | |
| % Retention of | 33.1% | 42.3% | 64.8% | 36.8% |
| flexural modulus | | | | |

All ingredient quantities are given in weight percent relative to the total weight of the composition.

TABLE 2

| | Example 4 | Example 5 | Comparative Example 2 |
|---|---|---|---|
| Polyamide 66 | 4 | 3.2 | 4.4 |
| Polyamide 6 | 6 | 4.8 | 6.6 |
| Novolac | 1 | 3 | — |
| Tungsten powder | 85 | 85 | 85 |
| Glass fibers | 4 | 4 | 4 |
| Freezing point (° C.) | 199 | 166 | 215 |
| Initial specific | 6.23 | 6.51 | 6.33 |
| gravity | | | |
| Specific gravity | 6.16 | 6.48 | 6.22 |
| after conditioning | | | |
| % Change in | −1.2 | −0.5 | −1.8 |
| specific gravity | | | |
| % Change in | 1.5 | 0.65 | 2.3 |
| volume | | | |
| % Change in | 0.33 | 0.17 | 0.47 |
| weight | | | |
| Flexural Modulus | 9873 | 10976 | 9184 |
| (DAM) (MPa) | | | |
| Flexural Modulus | 3227 | 6564 | 2710 |
| (after conditioning) | | | |
| (MPa) | | | |
| % Retention of | 32.7 | 59.8 | 29.5 |
| flexural modulus | | | |

All ingredient quantities are given in weight percent relative to the total weight of the composition.

TABLE 3

| | | | Comparative |
|---|---|---|---|
| | Example 4 | Example 5 | Example 2 |
| Shear rate (1/sec) | Viscosity (poise) | | |
| 56.7 | 295 | 187 | 322 |
| 106 | 157 | 100 | 173 |
| 567 | 30 | 19 | 33 |
| 1020 | 16 | 10 | 18 |
| 2834 | 6 | 4 | 7 |

1. A high density composition of matter comprising (a) polymeric binder comprising polyamide and phenolic novolac resin, and (b) metal or metal alloy powder.

2. The high-density composition of matter of claim 1 wherein said polyamide is based on monomers comprising hexamethylenediamine and/or caprolactam.

3. The high density composition of matter of claim 1 wherein in said polyamide (a) is selected from one or more of nylon 66; nylon 6; nylon 612; terpolymers of hexamethylenediamine, adipic acid, and terephthalic acid; and terpolymers of hexamethylene diamine, 2-methyl-1,5-pentanediamine, and terephthalic acid.

4. The high density composition of matter of claim 1 wherein said polymeric binder (a) consists of about 20 to about 98 weight percent of a blend of nylon 66 and nylon 6 and complementally about 2 to about 80 weight percent of said phenolic novolac resin.

5. The high density composition of matter of claim 1 wherein said metal or metal alloy powder (b) is present in from about 50 to about 96 weight percent of the composition.

6. The high density composition of matter of claim 1 wherein said metal or metal alloy powder (b) is tungsten.

7. The high density composition of matter of claim 1 further comprising up to about 10 weight percent of inorganic fibers.

8. The high density composition of matter of claim 1 further comprising up to about 2 weight percent of additives selected from the group consisting of processing aids, antioxidants, stabilizers, and lubricants.

9. The composition of any of claims 1-8 in the form of ammunition.

10. The composition of any of claims 1-8 in the form of a bullet.

11. A process for the preparation of ammunition comprising:
(i) Providing a mold suitably shaped and sized to manufacture the ammunition of interest;
(ii) Inserting into said mold a composition comprising (a) polymeric binder comprising polyamide and phenolic novolac resin, and (b) metal or metal alloy powder; and
(iii) Applying suitable heat and pressure to form the ammunition of interest; and
(iv) Withdrawing the ammunition of interest from said mold.

12. The process of claim 11 wherein said ammunition of interest is a bullet.

13. The process of claim 11 wherein said steps (ii) and (iii) are conducted via injection molding.
